(19) United States
(12) Patent Application Publication
(10) Pub. No.: US 2024/0017424 A1
(43) Pub. Date: Jan. 18, 2024

(54) PULL FORCE GRIPPER WITH MECHANICAL STOP

(71) Applicant: Dexterity, Inc., Redwood city, CA (US)

(72) Inventors: Kunal Vikas Shinde, Santa Clara, CA (US); Robert Moreno, East Palo Alto, CA (US); Salvador Perez, Jersey City, NJ (US); Andrew Lovett, Burlingame, CA (US); Robert Holmberg, Mountain View, CA (US)

(21) Appl. No.: 18/222,286

(22) Filed: Jul. 14, 2023

Related U.S. Application Data
(60) Provisional application No. 63/390,233, filed on Jul. 18, 2022.

(51) Int. Cl. B25J 15/06

(52) U.S. Cl. CPC B25J 15/0616

(57) ABSTRACT

A pull force based robotic end effector with an integrated mechanical stop is disclosed. In various embodiments, the end effector includes an end effector body having a top side and an operative side opposite the top side; a pull force gripper disposed on the operative side of the end effector body; and an integrated mechanical stop positioned on the operative side of the end effector body adjacent to the suction gripper, the mechanical stop extending from the operative side to an extent that allows the suction gripper to be operatively engaged with an object to be grasped.

### CROSS REFERENCE TO OTHER APPLICATIONS

This application claims priority to U.S. Provisional Patent Application No. 63/390,233 entitled PULL FORCE GRIPPER WITH MECHANICAL STOP filed Jul. 18, 2022 which is incorporated herein by reference for all purposes.

### BACKGROUND OF THE INVENTION

Robotic systems have been provided to move, stack, and unstack boxes and other objects or containers of objects. Examples include, without limitation, robotic systems configured to stack boxes on a pallet or in a truck or other shipping container or conveyance.

In some systems, end effectors mounted on a robotic arm may be used to grasp a box or other container, such as by applying a “pull” force from the top. Examples of pull force end effectors include, without limitation, end effectors that use suction, electrostatic adhesion, viscoelastic adhesion, so-called “draping” adhesion, magnetism, or other forces to pull and/or hold a surface of the item being grasped. Such an approach works best in situations in which the box or other container is rigid and sealed, e.g., by glue, and is sufficiently strong in its materials and construction to support the weight of the items within the box or other container. However, some containers may have attached lids and/or may be constructed of materials which result in the container sagging or otherwise opening/deforming once grasped from the top and lifted.

Typically, a robotic system plans a trajectory through which to move a box or other object from a starting location at which it is grasped to a destination location in which it is placed. In the case of a grasp using an end effector to grasp a box or other container at the top, the trajectory may be determined at least in part by the dimensions of the box. For example, the height, width, and depth of the box may be used to determine a trajectory and orientation for the box such that the box does not collide with any other object or structure in the workspace as it is moved through the trajectory. If the box or other container extends beyond the three-dimensional space it is expected to occupy, the trajectory may not be sufficient to avoid collision. For example, if a box sags, or an attached lid partly opens, or the box otherwise extends further than expected below the end effector that has been used to grasp the box from the top, the box may collide with another object or structure in the workspace.

### BRIEF DESCRIPTION OF THE DRAWINGS

Various embodiments of the invention are disclosed in the following detailed description and the accompanying drawings.

FIG. 1A is a diagram illustrating an embodiment of a robotic system to pick and place containers or similar containers.

FIG. 1B is a diagram illustrating an example of a center-opening container such as may be handled in an embodiment of a robotic system to pick and place containers or similar containers.

FIG. 1C is a diagram illustrating an example of a center-opening container such as may be handled in an embodiment of a robotic system to pick and place containers or similar containers.

FIG. 2A is a diagram illustrating an example of a conventional pull force-based end effector positioned to grasp a center-opening container.

FIG. 2B is a diagram illustrating an example of a conventional suction-based end effector having grasped and begun to lift a center-opening container.

FIG. 2C is a diagram illustrating an embodiment of a suction-based end effector with integrated mechanical stop, positioned to grasp a center-opening container.

FIG. 2D is a diagram illustrating an embodiment of a suction-based end effector with integrated mechanical stop, having grasped and lifted a center-opening container.

FIG. 3A is a diagram illustrating an embodiment of a suction-based end effector with integrated mechanical stop.

FIG. 3B is a diagram illustrating an embodiment of a suction-based end effector with integrated mechanical stop.

FIG. 3C is a diagram illustrating an embodiment of a suction-based end effector with integrated mechanical stop.

FIG. 3D is a diagram illustrating an embodiment of a suction-based end effector with integrated mechanical stop.

FIG. 4 is a diagram illustrating an embodiment of a suction-based end effector with a plurality of integrated mechanical stops.

FIG. 5 is a diagram illustrating an embodiment of a spring-loaded mechanical stop used in some embodiments of a suction-based end effector with integrated mechanical stop.

FIG. 6A is a diagram illustrating an embodiment of a shape-conforming foam-based mechanical stop used in some embodiments of a suction-based end effector with integrated mechanical stop, in position to grasp a container with an irregular top surface.

FIG. 6B is a diagram illustrating an embodiment of a shape-conforming foam-based mechanical stop used in some embodiments of a suction-based end effector with integrated mechanical stop, having grasped a container with an irregular top surface.

FIG. 7A is a diagram illustrating an embodiment of a suction-based end effector with integrated static bar type mechanical stop.

FIG. 7B is a diagram illustrating an embodiment of a suction-based end effector with integrated foam type mechanical stop.

FIG. 7C is a diagram illustrating an embodiment of a suction-based end effector with integrated spring type mechanical stop.

FIG. 7D is a diagram illustrating an embodiment of a suction-based end effector with integrated static bar type mechanical stop, having grasped and lifted a container.

FIG. 8A illustrates a suction cup with a rigid mechanical shroud used to provide a pull force-based end effector with integrated mechanical stop in various embodiments.

FIG. 8B illustrates a suction cup with a rigid mechanical shroud used to provide a pull force-based end effector with integrated mechanical stop in various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A pull force based robotic end effector with an integrated mechanical stop is disclosed. In various embodiments, a pull force based end effector as disclosed herein includes a mechanical stop positioned to prevent or reduce deformation and/or sagging, such as by impeding an attached lid of a container from opening when the container is grasped from the top and/or to otherwise prevent a grasped item from opening and/or prevent or minimize other sagging or deformation. For example, the mechanical stop may be positioned to align along with or athwart an opening edge of an attached lid or pair of lids, to prevent the lid from being pulled open (or too far open) when suction (or other pulling force) is applied to grasp and lift the container. As the pull force applied by the end effector pulls the lid door(s) up, the mechanical stop is engaged and applies a counterforce to hold the lid shut. In various embodiments, the mechanical stop provides rigidity and support to a container top and may prevent sagging or other deformation other than by holding an attached lid closed. For example, in the case of a partly deformable top surface, the pull force pulls the surface to engage with the mechanical stop, which in turn provides increased rigidity and/or minimizes deformation and/or sagging.

In various embodiments, the mechanical stop may be a static bar or other static and rigid structure. In some embodiments, the stop may include an integrated spring. In some embodiments, the stop may include at least in part a layer of foam or other shape-compliant material, e.g., to ensure more complete engagement with a lid having a non-uniform surface.

Various embodiments provide a robotic end effector that can be used to pick up items, such as boxes, etc. The end effector comprises (i) an end effector body having a top side and an operative side opposite the top side, (ii) a pull force gripper disposed on the operative side of the end effector body, and (iii) an integrated mechanical stop positioned on the operative side of the end effector body adjacent to the suction gripper, the mechanical stop extending from the operative side to an extent that allows the suction gripper to be operatively engaged with an object to be grasped.

In some embodiments, the end effector comprises a plurality of mechanical stops. The plurality of mechanical stops includes a first mechanical stop and a second mechanical stop. As an example, the first mechanical stop may be configured to be at least partly between two adjacent suction cups. The second mechanical stop may be configured to be at least partly between a different set of adjacent suction cups, or on an outside perimeter/circumference of the end effector.

In some embodiments, a mechanical stop comprises a slightly deformable bottom or distal surface (e.g., the surface that engages an item). For example, the mechanical stop comprises a rigid structure and a layer of a deformable structure at the distal end of the rigid structure to ensure that the mechanical stop accommodates/conforms to irregularities or non-uniformities in the top surface of the item to be engaged. The deformable structure may comprise a shape-conforming foam.

In some embodiments, the end effector comprises one or more mechanical stops. The one or more mechanical stops extend from a bottom surface/plate of the end effector at substantially the same length that one or more suctions cups extend from the bottom surface. As an example, a mechanical stop extends a length that is less than 5% shorter than the length that the suction cups extend from the bottom of the end effector. As another example, a mechanical stop extends a length that is less than 10% shorter than the length that the suction cups extend from the bottom of the end effector.

Various embodiments include an end effector comprising a rigid structure that serves to stiffen a top surface of an item (e.g., box) being grasped by the end effector. Examples of the rigid structure include a mechanical stop disclosed herein or a shroud configured around one or more suction-type grippers (e.g., suction cups) on the operative side of the end effector. Stiffening the top of the item enables the system to more accurately predict a location of the item as the system controls the robotic arm to move the item through space (e.g., from a source location to a destination location).

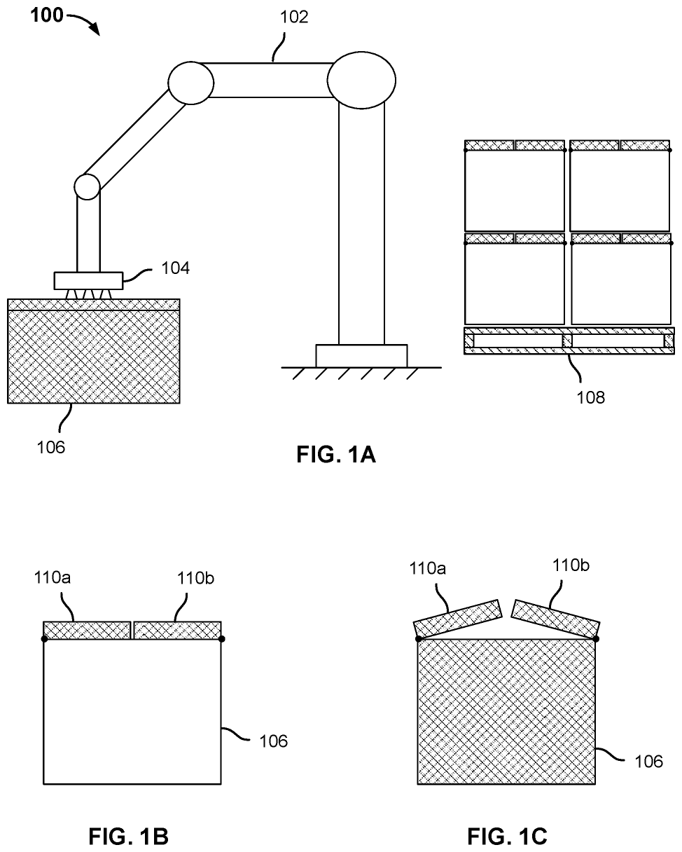

FIG. 1A is a diagram illustrating an embodiment of a robotic system to pick and place containers or similar containers. In the example shown, robotic system 100 includes a robotic arm 102 terminating in a suction-type end effector 104. While a suction-type end effector 104 is shown in FIG. 1A, in various embodiments a pull force type end effector other than a suction-based end effector may be used.

As shown in FIG. 1A, end effector 104 has been used to grasp an attached lid type container 106. A quantity of containers similar to container 106 are shown to have been stacked on a pallet 108 using the robotic arm 102 and end effector 104. Robotic system 100 may be deployed to perform various functions, such as singulating, kitting, and/or palletizing.

FIG. 1B is a diagram illustrating an example of a center-opening container such as may be handled in an embodiment of a robotic system to pick and place containers or similar containers. In the example shown, container 106 is shown to include an attached lid comprising lid parts 110a and 110b, each attached via a hinged connection to an opposite side or edge of the container 106.

FIG. 1C is a diagram illustrating an example of a center-opening container such as may be handled in an embodiment of a robotic system to pick and place containers or similar containers. In the partly open state shown in FIG. 1C, the operation of the hinged connections of the lid parts 110a and 110b is illustrated.

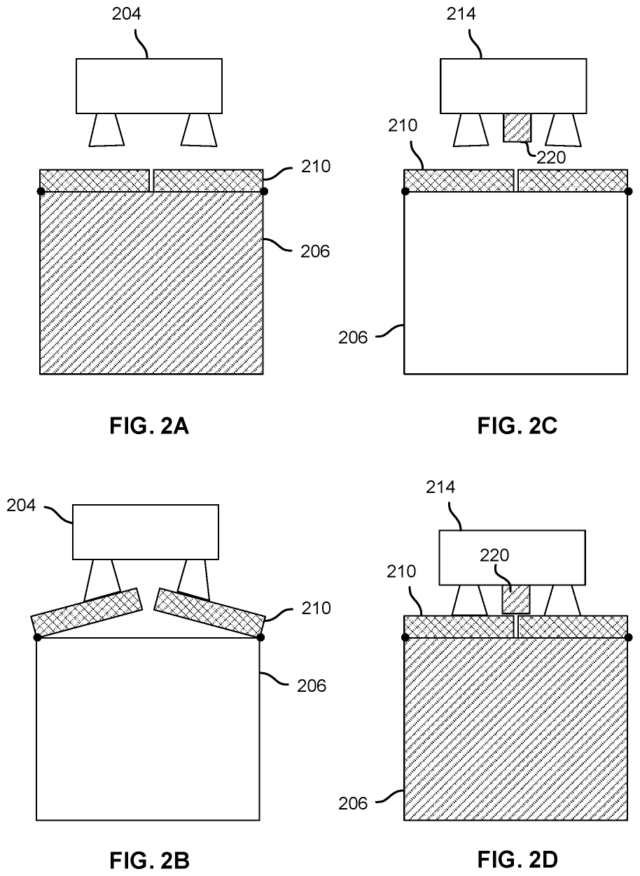

FIG. 2A is a diagram illustrating an example of a conventional pull force-based end effector positioned to grasp a center-opening container. In the example shown, end effector 204 (attached to a robotic arm not shown in FIG. 2A) is positioned above an attached lid container 206 having hinged top lid 210. In the state shown, the respective left and right (as shown) suction cups or sets of cups are aligned on either side of the central opening edges of the right and left parts of lid 210.

FIG. 2B is a diagram illustrating an example of a conventional suction-based end effector having grasped and begun to lift a center-opening container. In the state shown, end effector 204 has been used to attempt to grasp the container 206, via suction, and the robotic arm (not shown) has been used to lift up on the end effector 204 with the container 206 in its grasp. However, as shown, the lid 210 has been pulled partly open. As a result, the bottom of container 206 may extend lower than expected, which could result in a collision with other objects in the workspace, for example if a trajectory was planned to move the container 206 based on the dimensions of container 206 when the lid 210 is fully closed. In some circumstances, the partial opening of the parts of lid 210, as shown, could result in loss of suction and the container 206 being dropped. For example, silicone or other suction cups comprising the end effector 204 may deform, as shown in FIG. 2B, as a result of the lid 210 opening (or other deformation), which could result in a loss of vacuum seal and potentially dropping the container 206.

FIG. 2C is a diagram illustrating an embodiment of a suction-based end effector with integrated mechanical stop, positioned to grasp a center-opening container. In the example shown, the end effector 214 includes a mechanical stop 220 positioned, in this example, between the left and right suction cups (or sets of suction cups), along a longitudinal centerline of end effector 214. In various embodiments, mechanical stop 220 may be integrated into end effector 214 during manufacture or in the field, e.g., by using bolts or other fasteners to secure the mechanical stop to the underside of the end effector 214.

In some embodiments, prior to a container or other object being grasped, the suction cups extending further from the bottom surface of the body of end effector 214 than the mechanical stop 220, ensuring the suction cups are able to engage and grasp and object when the end effector 214 is position to engage the suction cups with the object mechanically with sufficient contact and engagement (e.g., via deformation of the suction cups) to ensure a seal is formed when suction is applied.

In various embodiments, mechanical stop 220 comprises one or more of a static bar; a spring-loaded bar or other spring-loaded structure; and one or more layers of foam or other partly deformable material, at least an outermost layer being sufficiently deformable to conform to an irregular surface or feature of the object being grasped and at least one or more other layers being sufficiently firm to apply a downward force to an upper surface of the object being grasped, as described further below.

FIG. 2D is a diagram illustrating an embodiment of a suction-based end effector with integrated mechanical stop, having grasped and lifted a center-opening container. In the state shown, end effector 214 has been used to grasp the container 206 by being positioned near the top surface, i.e., attached lid 210, while suction is applied. As shown, the mechanical stop 220 prevents the right and left parts of lid 210 from being pulled open as suction is applied and end effector 214 is raised by the robotic arm (not shown) to lift the container 206.

While an attached lid type container 106, 206 is shown in FIGS. 1A through 2D, in various embodiments a container or other item not having an attached lid may be handled. For example, a cardboard box or other container may have a top or other grasping surface that is subject to deformation and/or sagging, which could result in the bottom extent of the item as grasped being further from the end effector than anticipated. In various embodiments, mechanical stops such as those disclosed herein may be used to eliminate or minimize such deformation/sagging.

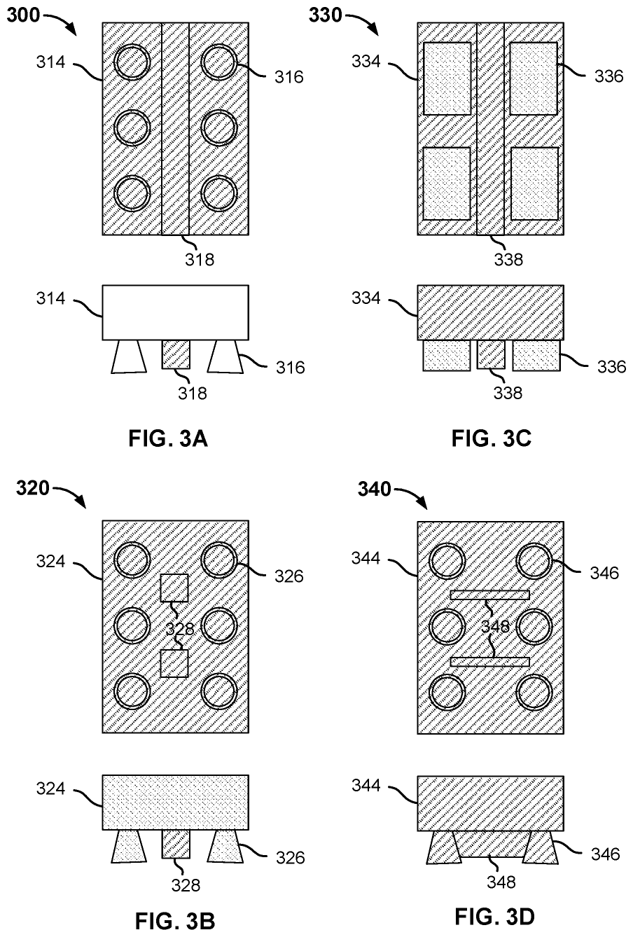

FIG. 3A is a diagram illustrating an embodiment of a suction-based end effector with integrated mechanical stop. In the example shown, end effector 300 includes a body 314 on which suction cups 316, divided into left and right sets, as shown, are mounted. Suction modules, not shown, are robotically controlled to apply a suction via cups 316 to grasp objects, as described herein. End effector 300 further includes a mechanical stop 318, which runs along the central longitudinal axis of body 314, between the left and rights sets of suction cups 316. In various embodiments, mechanical stop 318 comprises a static bar having sufficient strength and rigidity to apply a downward force to an object that has been grasped using suction cups 316, e.g., to prevent container lids from pulling open, as shown in FIGS. 2C and 2D.

FIG. 3B is a diagram illustrating an embodiment of a suction-based end effector with integrated mechanical stop. In the example shown, end effector 320 includes a body 324 on which suction cups 326, divided into left and right sets, as shown, are mounted. Suction modules, not shown, are robotically controlled to apply a suction via cups 326 to grasp objects, as described herein. End effector 320 further includes mechanical stops 328, which are positioned along the central longitudinal axis of body 324, between the left and rights sets of suction cups 326. In various embodiments, mechanical stops 318 each comprises a static block having sufficient strength and rigidity to apply a downward force to an object that has been grasped using suction cups 326, e.g., to prevent container lids from pulling open, as shown in FIGS. 2C and 2D.

FIG. 3C is a diagram illustrating an embodiment of a suction-based end effector with integrated mechanical stop. In the example shown, end effector 330 includes a body 334 on which foam type suction pads 336, divided into left and right sets, as shown, are mounted. Suction modules, not shown, are robotically controlled to apply a suction via suction pads 336 to grasp objects, as described herein. End effector 330 further includes a mechanical stop 338, which runs along the central longitudinal axis of body 334, between the left and rights sets of suction pads 336. In various embodiments, mechanical stop 338 comprises a static bar having sufficient strength and rigidity to apply a downward force to an object that has been grasped using suction pads 336, e.g., to prevent container lids from pulling open, as shown in FIGS. 2C and 2D. In some embodiments, mechanical stop 338 comprises a single or multilayer foam bar and at least one layer of which sufficient strength and rigidity to apply a downward force to an object that has been grasped using suction pads 336.

FIG. 3D is a diagram illustrating an embodiment of a suction-based end effector with integrated mechanical stop. In the example shown, end effector 340 includes a body 344 on which suction cups 346, divided into left and right sets, as shown, are mounted. Suction modules, not shown, are robotically controlled to apply a suction via cups 346 to grasp objects, as described herein. End effector 340 further includes mechanical stops 348, which in this example run crosswise at locations spaced along the central longitudinal axis of body 344. In various embodiments, each of the mechanical stops 348 comprises a static bar having sufficient strength and rigidity to apply a downward force to an object that has been grasped using suction cups 346, e.g., to prevent container lids from pulling open, as shown in FIGS. 2C and 2D.

While end effectors comprising suction cups and pads are included in the examples shown in FIGS. 3A through 3D, in various embodiments other types of end effector and grasping force may be used. In various embodiments, one or more of the types of mechanical stop in the examples shown in FIGS. 3A through 3D may be used, singly or in combination, and the number, size, dimension, arrangement, and orientation of mechanical stops may be varied.

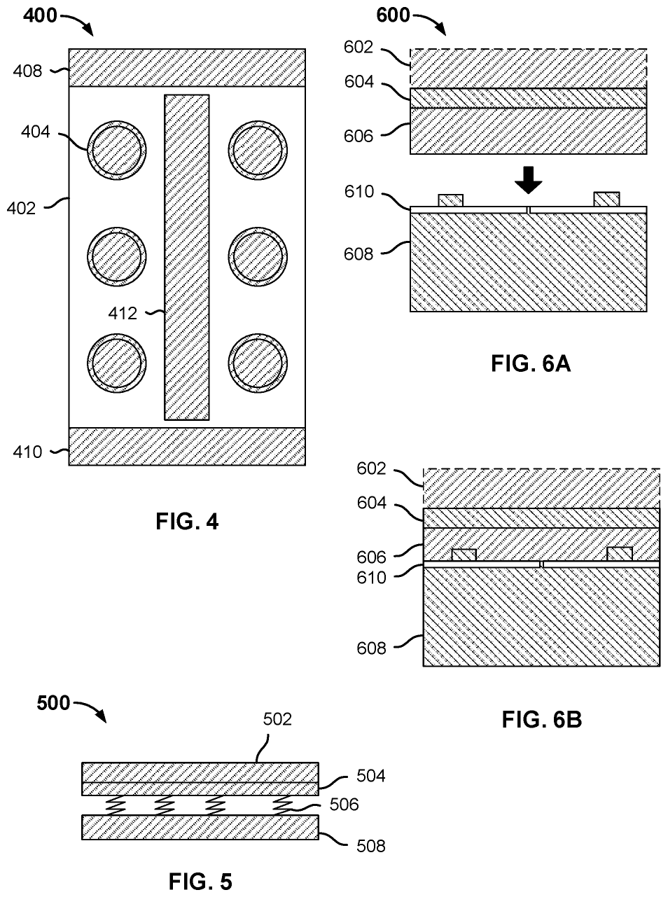

FIG. 4 is a diagram illustrating an embodiment of a suction-based end effector with a plurality of integrated mechanical stops. In the example shown, end effector 400 includes a body 402 on which suction cups 404 are mounted. Mechanical stops 408, 410, and 412 are mounted on the underside of body 402, adjacent to the suction cups 404, each having the dimensions, orientation, and mounting location as shown. In various embodiments, in operation the longitudinal mechanical stop 412 is aligned with the central opening edges of the left and right lid portions, applying a downward force to prevent the lids from opening. The crosswise stops 408 and 410 similarly apply a downward force along the side edges of the lid portions, further preventing the lids from opening. In operation, in various embodiments, grasping of a container or other attached lid container using suctions cups 404 pulls the container up and into physical contact with the mechanical stops 408, 410, and 412, resulting in the mechanical stops 408, 410, and 412 applying a downward force along the edges of the lids that might otherwise tend to come partly open, i.e., the edges other than the outer longitudinal edge at which they are attached, e.g., by hinges, to the container portion of the container.

FIG. 5 is a diagram illustrating an embodiment of a spring-loaded mechanical stop used in some embodiments of a suction-based end effector with integrated mechanical stop. In the example shown, mechanical stop 500 includes a base portion 504 to mount the stop 500 to an end effector body 502; a set of springs 504; and a container engagement portion 508. In operation, the end effector body 502 is positioned over the top of the container. On application of a suction force, the container lid is pulled up and into physical contact with container engagement portion 508. Springs 506 compress, to a point, and apply a force of extension to the container engagement portion 508, keeping it tightly engaged with the container lid, and applying a downward force to prevent the container lid from opening.

FIG. 6A is a diagram illustrating an embodiment of a shape-conforming foam-based mechanical stop used in some embodiments of a suction-based end effector with integrated mechanical stop, in position to grasp a container with an irregular top surface. In the example shown, mechanical stop 600 includes a two-layer foam stop comprising an outer layer 606 and an inner layer 604 secured to an end effector body 602. The outer layer 606 comprises a relatively more deformable foam than the inner layer 604, in various embodiments. In the state shown in FIG. 6A, the end effector body 602 and mechanical stop 600 are positioned above a container 608 having a center-opening attached lid 610, for example as a robotic system may position end effector body 602 and mechanical stop 600 to grasp the container 608 from above.

FIG. 6B is a diagram illustrating an embodiment of a shape-conforming foam-based mechanical stop used in some embodiments of a suction-based end effector with integrated mechanical stop, having grasped a container with an irregular top surface. In the state shown in FIG. 6B, the end effector body 602 and mechanical stop 600 have been pressed down onto the top surface of lids 610 of container 608. The outer foam layer 606 has deformed to accommodate the irregularities in the top surface of the lids 610, ensuring more complete physical engagement. The relatively more rigid foam layer 604 maintains its shape (more) and enables a downward force to be applied to prevent the lid 610 from pulling open.

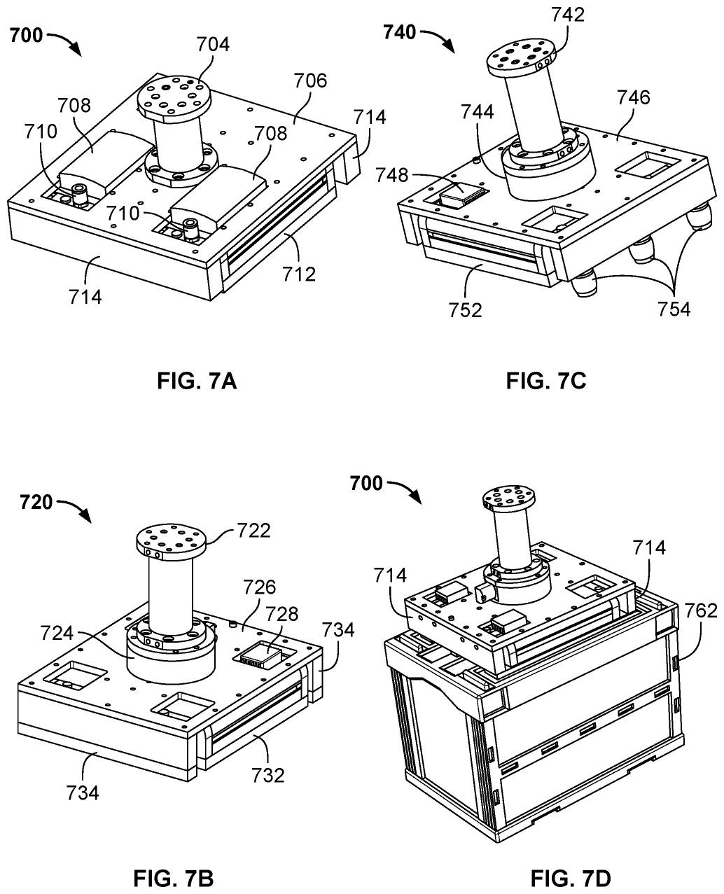

FIG. 7A is a diagram illustrating an embodiment of a suction-based end effector with integrated static bar type mechanical stop. In the example shown, end effector 700 includes a connection post 704 to bolt the end effector to the operative end of a robotic arm (not shown). The connection post 704 is bolted to an end effector body 706 having orifices and mounting points to attach suction modules 708, which use compressed air provided via air connections 710, under robotic control, to generate a vacuum to apply suction using suction pad 712 on the opposite side of end effector body 706. In the example shown, a set of mechanical stops comprising crosswise static bars 714 and, in some embodiments, a central longitudinally mounted static bar, like stop 412 of FIG. 4, not shown in FIG. 7A, are included.

As described above, in operation the suction modules 708 use compressed air provided via connections 710 to apply suction via suction pads 712, e.g., to grasp a container from above. The suction pulls the container lids up and into engagement with the mechanical stops, in this example static bars 714, preventing the container lids from opening.

FIG. 7B is a diagram illustrating an embodiment of a suction-based end effector with integrated foam type mechanical stop. In the example shown, end effector 720 includes a connection post 722 to bolt the end effector to the operative end of a robotic arm (not shown). The connection post 722 is connected to end effector body 726 via a force sensor module 724. The body 726 has orifices and mounting points to attach suction modules 728, which use compressed air, under robotic control, to generate a vacuum to apply suction using suction pad 732 on the opposite side of end effector body 726. In the example shown, a set of mechanical stops comprising crosswise stops 734 and, in some embodiments, a central longitudinally mounted stop, like stop 412 of FIG. 4, not shown in FIG. 7B, are included. In some embodiments, the stops 734 include an outer layer of relatively more deformable foam rubber, as in the example shown in FIGS. 6A and 6B. As an example, the deformable foam rubber is configured to deform to irregular shapes in the top surface of the item to be grasped by end effector 720.

FIG. 7C is a diagram illustrating an embodiment of a suction-based end effector with integrated spring type mechanical stop. In the example shown, end effector 740 includes a connection post 742 to bolt the end effector to the operative end of a robotic arm (not shown). The connection post 742 is connected to end effector body 746 via a force sensor module 744. The body 746 has orifices and mounting points to attach suction modules 748, which use compressed air, under robotic control, to generate a vacuum to apply suction using suction pad 752 on the opposite side of end effector body 746. Spring-loaded mechanical stops 754 positioned along opposite sides of the underside of body 746, and on either side of suction pad 752, provide mechanical engagement with and apply downward force on the unattached side edges of the container lid doors, as described herein, to prevent opening.

FIG. 7D is a diagram illustrating an embodiment of a suction-based end effector with integrated static bar type mechanical stop, having grasped and lifted a container. In the example shown, end effector 700 of FIG. 7A has been used, under robotic control, to grasp container 762. The static bar-type mechanical stops 714 are shown positioned across the center opening edges of the side-attached lids of container 762, applying a downward force to prevent the doors from opening.

While suction type end effectors are illustrated in and described in connection with FIGS. 3A through 7D, in various embodiments other types of pull force based end effectors may be used including, without limitation, end effectors that use electrostatic adhesion, viscoelastic adhesion, so-called “draping” adhesion, magnetism, or other forces to pull and/or hold a surface of the item being grasped.

In various embodiments, an end effector comprises a shroud(s) that surrounds one or more suction cups. For example, the end effector may comprise a shroud for each of its suction cups. Suctions cups are generally made of compliant material and during normal operation are subject to wear and tear, including damage that may be caused via collisions with other objects in the workspace (e.g., such as with other items in the workspace as the robotic arm is moving to grasp an item). Similar to the mechanical stops described herein with respect to other examples, the shrouds provide a pre-loading that serves to stiffen the top of the item being grasped. For example, the end effector comprises a suction cup disposed within a cavity defined by a shroud, and the suction cup operates to pull the item towards the operative side of the end effector (e.g., to pull the item up). The shroud provides a counteracting force (e.g., in the direction opposite to the direction of the suction force caused by the suction cup) that serves to stiffen the top of the item being grasped. In some implementations, a plurality of suction cups is encased with a corresponding shroud. The shrouds encasing the plurality of suction cups create a localized stiffening of the top of the item grasped by the suction cups.

In addition to providing the mechanical support into stiffen the top of the item, the shroud protects the suction cup from damage such as damage caused by collision with other objects in the workspace. Accordingly, the use of shrouds to encase the suction cup may extend the life of each suction cup, thereby reducing the cost of the system.

The use of shrouds comes at the cost of reducing the flexibility for the suction-type gripper to conform an irregular (e.g., non-rectangular) item or non-flat items. For example, the shrouds generally enforce a flat surface on the surface of the item being grasped. However, the material used for the shrouds may be selected particularly to be sufficiently rigid to provide the localized stiffening at the top of the item being grasped while being maximally flexible subject to the rigidity constraint.

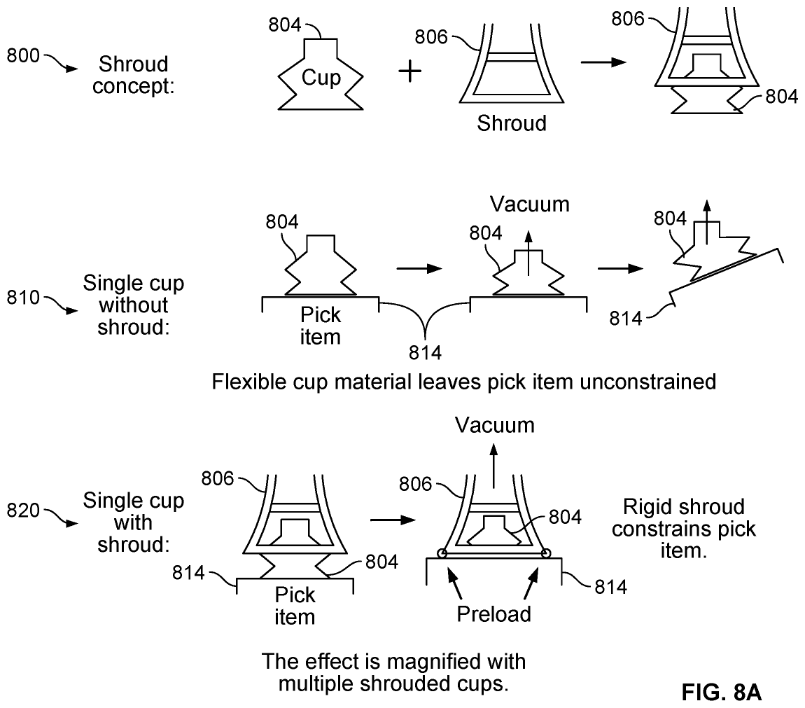

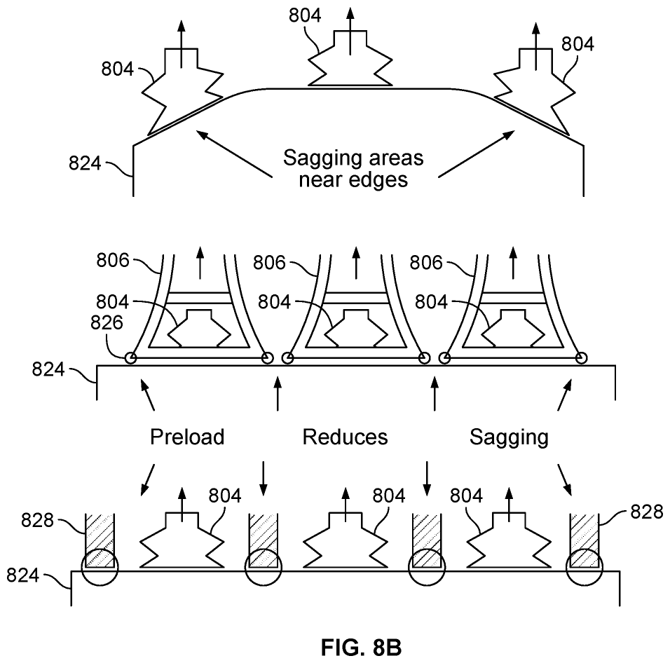

FIG. 8A illustrates a suction cup with a rigid mechanical shroud used to provide a pull force-based end effector with integrated mechanical stop in various embodiments. In the example shown, the images 800 at top show a silicone or other deformable suction cup 804 being integrated with a rigid mechanical shroud 806 to provide a shrouded suction cup 804, 806. In various embodiments, an end effector as disclosed herein includes a plurality of shrouded suction cups 804, 806. When suction is applied, a bottom edge/surface of the shroud 806 engages with and becomes preloaded with respect to the grasped (e.g., top) surface of the item being grasped, which constrains the adjacent material of the item (i.e., by holding it against the shroud 806) and reduces/prevents deformation/sagging.

As the middle set of images 810 show, without the shroud 806 the top surface of the item 814 may open (e.g., as in the attached lid container examples above) and/or deform, resulting in sagging (e.g., bottom of item extending further away from the end effector than computed or expected) and potentially deformation of the suction cup 804 and possibly loss of vacuum seal.

The bottom set of images 820 show that integration of the shroud 806 with suction cup 804 results in preloading and constraint of the pick item 814, as illustrated in the images 820 and described above, which eliminates/reduces lid opening and/or top surface deformation of the sort illustrated in images 810.

FIG. 8B illustrates a suction cup with a rigid mechanical shroud used to provide a pull force-based end effector with integrated mechanical stop in various embodiments. In the example shown, the top image illustrates an item 824 the top surface of which is sagging at the edges, near the outer suction cups 804. For example, item 824 may include a heavy payload inside a cardboard or other partly deformable box. Using an end effector comprising suction cups 804 to grasp and lift the item 824 may cause the top surface to sag, as shown, potentially resulting in a collision or loss of suction.

The middle image of FIG. 8B shows that, by comparison, when shrouded suction cups 804, 806 are used the engagement of the bottom edge of the shrouds 806 with the top surface of item 824, and the preloading that occurs when suction is applied reduces sagging.

The bottom image of FIG. 8B shows and alternative embodiment in which integrated mechanical stops 828 (see, e.g., FIGS. 3A through 5) are positioned alongside the suction cups 804, having a similar effect and principle of operation as the shrouds 806 shown in the middle image above.

In various embodiments, use of techniques and structures disclosed herein prevents container lids from opening and/or the top surface of an items sagging (excessively) when grasped, using suction or other pull forces, such as electrostatic or magnetic force, from the top, reducing the likelihood of the container from being dropped and/or colliding with other objects or obstacles in the workspace.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic end effector, comprising:
an end effector body having a top side and an operative side opposite the top side;
a pull force gripper disposed on the operative side of the end effector body; and
an integrated mechanical stop positioned on the operative side of the end effector body adjacent to the suction gripper, the mechanical stop extending from the operative side to an extent that allows the suction gripper to be operatively engaged with an object to be grasped.

2. The end effector as recited in claim 1, wherein the mechanical stop is positioned to engage mechanically with at least a portion of the object when a vacuum is applied to the suction gripper to grasp the object.

3. The end effector as recited in claim 2, wherein the object comprises a container with an attached lid and the mechanical stop prevents the attached lid from opening when the container is grasped from the top.

4. The end effector as recited in claim 3, wherein the attached lid comprises a center opening lid comprising two doors hinged at opposite sides of the container.

5. The end effector as recited in claim 4, wherein the mechanical stop is positioned along a centerline of the operative side of the end effector body.

6. The end effector as recited in claim 5, wherein the mechanical stop is positioned between a first and second set of suction grippers.

7. The end effector as recited in claim 1, wherein the suction gripper comprises a foam-type suction gripper.

8. The end effector as recited in claim 1, wherein the suction gripper comprises two sets of suction cups, each comprising one or more suction cups.

9. The end effector as recited in claim 1, further comprising a vacuum generator configured to apply a vacuum to the suction gripper.

10. The end effector as recited in claim 1, wherein the mechanical stop comprises a static bar.

11. The end effector as recited in claim 1, wherein the mechanical stop comprises a plurality of static bars, including a first static bar positioned centrally along a longitudinal axis of the end effector body and a second static bar positioned along a lateral axis that is substantially perpendicular to the longitudinal axis.

12. The end effector as recited in claim 1, wherein the mechanical stop comprises a spring.

13. The end effector as recited in claim 1, wherein the mechanical stop comprises a layer of shape-conforming foam.

14. The end effector as recited in claim 1, wherein the mechanical stop comprises a rigid shroud that at least partly surrounds a deformable suction cup.

15. The end effector as recited in claim 1, wherein a stop length over which the integrated mechanical stop extends from the operative side of the end effector body is shorter than a gripper length over which a pull force gripper extends from the operative side of the end effector body.

16. The end effector as recited in claim 15, wherein the stop length is less than 10% shorter than the gripper length.

17. The end effector as recited in claim 16, wherein the stop length is less than 5% shorter than the gripper length.

18. The end effector as recited in claim 16, wherein the stop length is less than 2% shorter than the gripper length.
